(19) United States
(12) Patent Application Publication
(10) Pub. No.: US 2024/0169259 A1
(43) Pub. Date: May 23, 2024

(54) REAL-TIME ASSESSMENT OF RESPONSES TO EVENT DETECTION IN UNSUPERVISED SCENARIOS

(71) Applicant: Dell Products L.P., Round Rock, TX (US)

(72) Inventors: Paulo Abelha Ferreira, Rio de Janeiro (BR); Vinicius Michel Gottin, Rio de Janeiro (BR); Pablo Nascimento da Silva, Niteroi (BR)

(21) Appl. No.: 18/057,913

(22) Filed: Nov. 22, 2022

(51) Int. Cl. G06N 20/00

(52) U.S. Cl. CPC G06N 20/00

(57) ABSTRACT

One method includes receiving, by a near edge node from a far edge node, a trajectory class determined by the far edge node, selecting, by the near edge node, a distribution that corresponds to the trajectory class, receiving, by the near edge node, the distribution, and transmitting, by the near edge node to the far edge node, the distribution, wherein the distribution is usable by the far edge node to determine a label to be assigned to a prediction of interest generated by a model instance running at the edge node.

### FIELD OF THE INVENTION

Embodiments of the present invention generally relate to event detection in unsupervised contexts. More particularly, at least some embodiments of the invention relate to systems, hardware, software, computer-readable media, and methods, for using response time-to-action information, in a real time scenario, to enable identification of a label for a detected event.

### BACKGROUND

It can be difficult to obtain labels for events of interest to be used in the creation and training of a machine learning model. For example, if an event of interest involves dangerous activity, it would be undesirable to engage in, or encourage, that dangerous activity just so that a label could be obtained. However, the lack of available labels can impair the ability to assess the operation of a machine learning model.

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

### BRIEF DESCRIPTION OF THE DRAWINGS

FIG. 1 discloses aspects of an environment in which an ML model may be deployed.

FIG. 2 discloses aspects of an event trajectory table.

FIG. 3 discloses an initial state for an embodiment of the invention.

FIG. 4 discloses an example filtered trajectory table.

FIG. 5 discloses example distributions of response times for each prediction, and action, for each trajectory class.

FIG. 6 discloses some operations of an edge node and a near edge node, according to an embodiment.

FIG. 7 discloses an example method according to an embodiment.

FIG. 8 discloses a computing entity operable to perform any of the disclosed methods, processes, and operations.

### DETAILED DESCRIPTION OF SOME EXAMPLE EMBODIMENTS

Some embodiments of the present invention generally relate to event detection in unsupervised contexts. More particularly, at least some embodiments of the invention relate to systems, hardware, software, computer-readable media, and methods, for using response time-to-action information, in a real time scenario, to enable identification of a label for a detected event.

In general, an example embodiment of the invention may comprise an offline stage, and an online stage. In an embodiment of an offline stage, a confidence threshold may be obtained that may be used, for example, to identify equipment operators with a sufficiently high efficiency score. For those operators, a distribution may be obtained of operator response times for one or more specified actions of a domain. These distributions may be held at one or more near edge nodes, for example.

In an embodiment of an online stage, which may be implemented on-demand or automatically, for example, an edge node may identify its current trajectory class, and then communicate that trajectory class to one of the near edge nodes. The near edge node may then obtain the appropriate distribution(s), which may have been generated using historical information regarding actions taken by the operators identified during the offline stage, for that trajectory class.

An instance of an event detection model deployed at one of the edge nodes may then generate a prediction, which may be a prediction of interest, that is, a prediction that relates to an occurrence of a particular event. If the prediction does not concern an event of interest, such as a dangerous event for example, the online stage may stop. On the other hand, if the prediction concerns an event of interest, then the actions, if any, taken by an operator in response to the event may be monitored and used as a basis for labeling that prediction as, for example, true, false, or undetermined. In an embodiment, the actions taken by the operator may alternatively correspond to a different event class than the one for which the prediction was made.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment of the invention may enable the creation of event labels and/or prediction labels in environments, possibly dangerous environments, in which it would otherwise be impractical, or impossible, to obtain such labels. An embodiment may determine likely labels for model predictions in near real time, so as to possibly enable timely refinements to the model, where a label indicates such a need. An embodiment may be employed in any environment in which an edge node runs an event prediction model and is able to communicate with a near edge node and/or a central node. An embodiment may employ information about the performance of humans and/or machines in determining labels for model predictions. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

One or more embodiments deal with event detection in edge environments. Particularly, an embodiment may consider an edge environment in which one or more edge nodes may take the form of respective mobile devices that may be equipped with sensors and processing capabilities. For the purposes of illustration, reference is made herein to an example embodiment in which mobile entities, such as forklifts equipped with sensors, define one possible use case.

References to this example embodiment involving forklifts are made by way of illustration, and are not intended to limit the scope of the invention in any way. More generally, one or more embodiments may be implemented in any edge environment in which one or more edge devices, which may or may not be mobile, operate. The edge devices may comprise hardware and/or software and may, in an embodiment, take the form of IoT (internet of things) devices.

In more detail, and with reference to the forklift example, an embodiment may involve a group of forklifts operating at a large-scale logistics warehouse adequately equipped as an on-premise edge environment. In this environment, event detection model may be obtained and deployed to the mobile devices, or edge nodes. In this example embodiment, an approach is considered for detecting dangerous cornering events in trajectories of mobile devices at the far edge. The model may, for example, be used for signaling alarms to forklift operators in the warehouse environment. In such an environment, it may be the case that there are no labels for relevant events. Thus, an event detection model may have to be obtained in an unsupervised fashion. Furthermore, in the cases in which human revision is possible, the labels may be obtained only after a long delay and thus cannot be effectively used for real-time orchestration and operation.

With the foregoing considerations in view, one or more example embodiments may involve the performance of various processes and operations. An embodiment may comprise offline operations and/or online operations, such as the following operations:

Offline Operations:
1. leverage historical data that relates operator actions, for example, actions performed by forklift operators, to the event predictions of a machine learning (ML) model;
2. extract high-confidence instances of correct event predictions based on operator actions taken in response to alarms raised by the predictions;
3. determine the distributions of operator response times to those alarms;
Online operations (may be performed after the model predicts an event and an alarm is raised concerning that event);
4. determine the time it takes for an operator to perform an action after that alarm, that is, a current response time;
5. determine how likely the prediction given by the model was to be correct, based on the comparison of the current response time to the historical operator response times; and
6. determine any anomalous cases—for example, in which an operator is not reacting to the provided alarms in a reasonable fashion.

### B. Context for Some Example Embodiments

As noted earlier herein, embodiments may be implemented in any of a variety of operating environments. In the logistic space, for example, a prominent edge domain is that of warehouse management and safety, where there may be multiple mobile devices as requiring decisions in real time, such as forklift trucks. The data collected from the respective trajectories of these devices at a warehouse may be leveraged into Machine Learning (ML) models to, for example, optimize operation, or to address dangerous circumstances, via object/event detection approaches.

Some example embodiments focus on models that are already deployed to edge nodes and that perform event detection, such as for dangerous cornering events for example. An embodiment may assume that monitoring of the device operator actions is performed. An embodiment may leverage a framework for continuous assessment of event detection models designed for unsupervised settings: a table that captures the relation between model predictions and actions for a specific operator, and the determination of efficiency scores for specific operators based on that table.

In more detail, an embodiment comprises an approach that considers the time-to-action of operators when the operator is given an alarm, that is, an alarm following from an event prediction. An embodiment may then identify the label for the event based on the comparison of that time-to-action to the distribution of time-to-action in historical data regarding operator actions and time-to-action. This approach may provide a ‘label’ for the classification problem related to event detection in real time. Furthermore, this approach may further help indicate anomalies, such as when the time-to-action of the operator is deemed to be too different from the expected values.

### C. General Aspects of Some Example Embodiments

As noted earlier herein, one or more embodiments may concern circumstances in which a deployed ML model operates in an unsupervised setting. For example, machine learning models may make use of labels in order to be trained, and their performance assessed. However, in scenarios such as the warehouse/forklift example disclosed herein, it might be infeasible to collect labels for dangerous events. For example, it may not be desirable to have a forklift perform a dangerous operation in order to be able to collect labels, due to the obvious risks involved in such a collection procedure. Further, even if it were feasible to collect a small amount of such data, and then train a model using that data, it may be difficult to assess the performance of that model on new data. Thus, embodiments of the invention may be well suited for use in circumstances in which the number of available labels would otherwise, that is, absent the employment of such embodiments, be insufficient for training and for assessing the model in production.

Further, assessing the performance of a model in a production environment may be an important aspect of ensuring proper deployment and compliance with expectations. However, since conventional approaches provide no labels for assessing the model in production, embodiments of the invention may employ unsupervised approaches for model performance assessment. That is, an embodiment may operate to assess the performance of a model, operating in a production environment, notwithstanding the inability to collect labels for the event(s) with which that model is concerned, such as dangerous forklift cornering events for example.

### D. Detailed Description of Some Example Embodiments

### D.1 Background and Definitions

D.1.1 Edge Environment

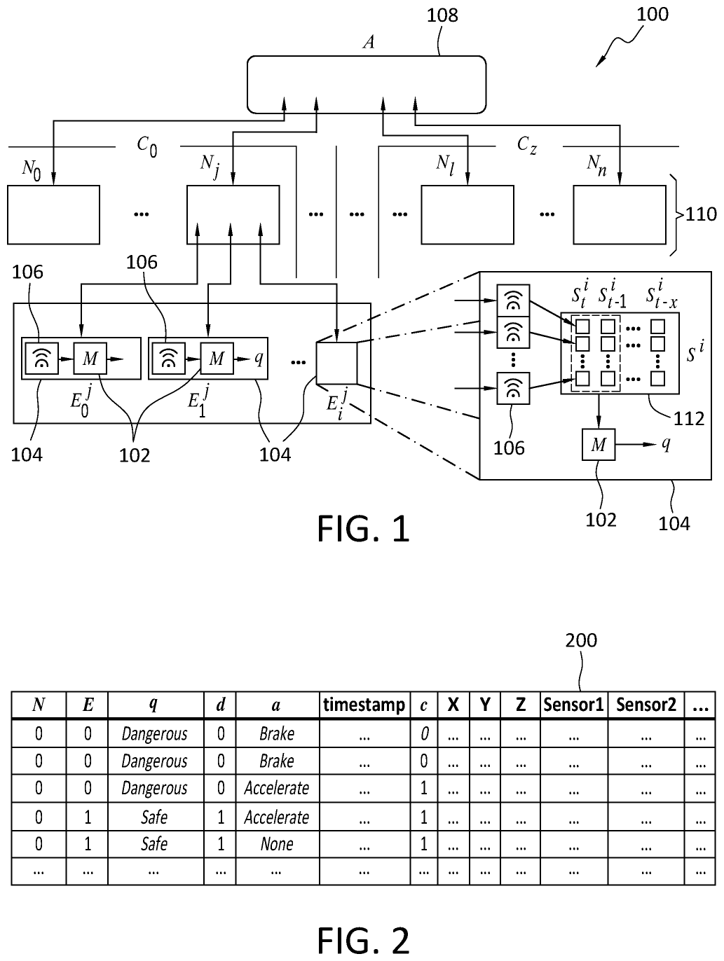

One example of an edge environment in which an embodiment may be employed is denoted generally at 100 in FIG. 1 (note that a glossary of symbols is also provided in the Appendix, which is attached here to and is incorporated herein, in its entirety, by this reference). Particularly, FIG. 1 discloses an example of an on-premise edge environment 100 with deployed models 102 at the far edge nodes 104. The contents of an example node E; 104 are shown in detail, as further discussed below. Each of the far edge nodes 104 may comprise one or more respective sensors 106 operable to gather and/or generate data and metadata concerning the operation of the far edge node 104 in which the sensor 106 is deployed.

The example edge environment 100 may further comprise a central node A 108, which may have substantial data storage and processing capabilities, or at least data storage and processing capabilities beyond what any of the far edge nodes 104 could provide. The central node 108 A may communicate, while also handling orchestration related to the communication, with a set of near-edge nodes N₀, . . . , Nₙ 110 which may be conceptually separated into sets C₀, . . . , C_{z}. Each node N 108 may, in turn, communicate with a set of the far-edge nodes E₀^{j} . . . E₁^{j} 104 or, simply, far-edge nodes 104. As noted, the far-edge nodes 104 may be equipped with sensors 106, whose collections may comprise the input to the model M 102 deployed at the far-edge nodes 104.

Internally, as depicted for the illustrative edge node Eᵢ^{j} 104, the sensor data collections stream may be locally stored as the set Sⁱ 112. Typically, a set of the most recent collections may be kept, with the most recent collections being used at time t for inference. In the example of FIG. 1, the example edge node Eᵢ^{j} 104 is detailed with the structure of the sensor 106 data stream collections. Leveraging the sensor 106 collections 112 most recently collected, the inference q of the model M 102 may be used for decision making in very quick fashion, that is, with very little delay after the sensor 106 input is provided to the model M 102. The output q of the model M 102, which may comprise an event indication, may be used by the far edge nodes 104 and/or communicated from the far edge nodes 104, by way of a near edge node 110, to central node A 108 for operational management and reporting tasks.

Aspects of an example embodiment are disclosed herein in connection with an example embodiment of a large-scale logistics domain. In this example embodiment:
a warehouse corresponds to an organization (e.g., C₀), with one or more near-edge node(s) (N₀, N₁, . . . ) as infrastructure deployed on-premise;
forklifts, either autonomous or human-operated, are mobile devices equipped with sensors and operating as far-edge nodes E₀⁰, E₁⁰, . . . , E₀¹, E₁¹ . . . ; and
a model M for dangerous cornering detection is deployed to the edge nodes.

Detecting a dangerous cornering operation by a forklift operator is an example of real-time event detection. Other examples of events of interest in a warehouse logistics domain in which forklifts operate may comprise the detection of excessive load, dock-entering/exiting, collisions, or, more generally, all kinds of signals and or/alarms raised by real-time monitoring systems.

D.1.2 Unsupervised Model Assessment Via Trust Scoring

In U.S. patent application Ser. No. 17/812,638, entitled AUTOMATIC ASSESSMENT OF UNSUPERVISED MODELS VIA TRUST SCORING IN UNSUPERVISED EDGE DOMAINS, and filed 14 Jul. 2022 (incorporated herein in its entirety by this reference) (hereafter the “'638 Application”), there are disclosed embodiments of an approach to provide automatic assessment of event detection models. An embodiment of that approach may comprise various aspects concerning one or more embodiments of the present invention.

One of such aspects is a trajectory classification module. In the '638 Application, embodiments of a trajectory classification process are disclosed. An embodiment of this trajectory classification process may consider a set of most-recent sensor collections, possibly defined by positioning and other kinds of sensor data, as a trajectory, and may then elect one or more representative typical trajectories as respective ‘classes.’ It may be assumed, in some instances at least, that a set of typical trajectories may be determined such that each sub-trajectory is associated to exactly one typical trajectory. Other approaches based on clustering and/or classification may apply. The process should be known and executable at the edge nodes.

Another of such aspects, the trajectory classification module being the first, comprises a trajectory table. Embodiments of a trajectory table may relate, for each trajectory class, the observed operator actions in relation to the model predictions. The table 200 in FIG. 2 is an example of a possible data structure to relate sensor data coming from each mobile device E and the actions a of operator d at each of the possible near edge nodes N. Particularly, FIG. 2 discloses an example event-trajectory table T 200 for the illustrative use case of a dangerous cornering detection model. In FIG. 2, the table 200 comprises a log of the actions taken by forklift operators immediately after cases in which a cornering event a was deemed “Dangerous” or “Safe.” The Appendix hereto discloses details on how a trajectory table may be collected and composed in an edge environment.

### D.2 Example Embodiments

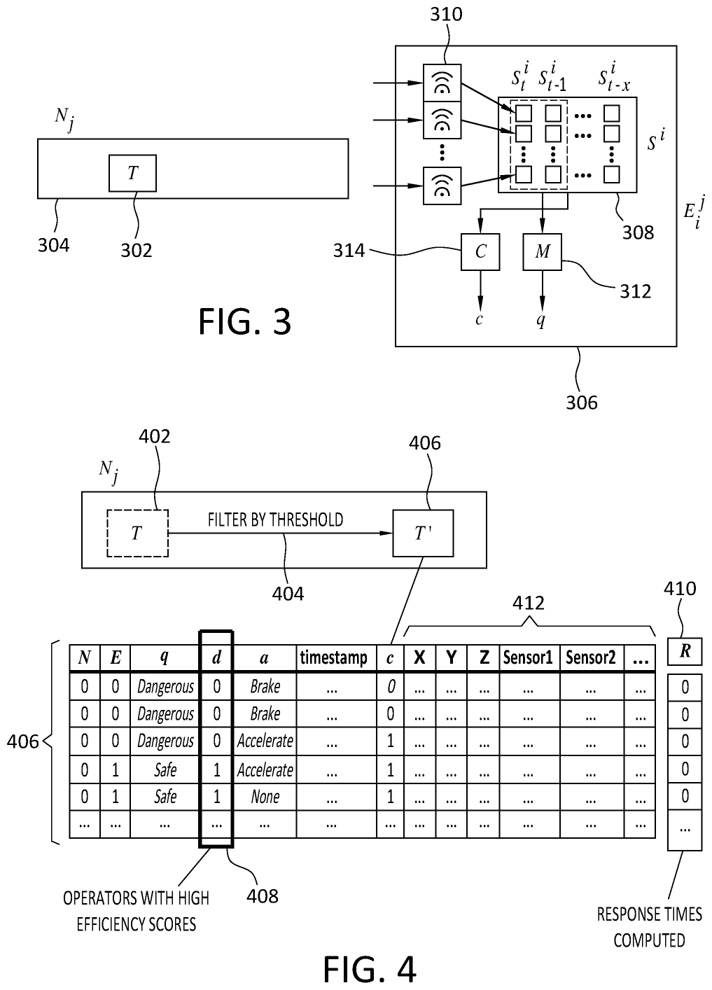

One or more embodiments of the invention may leverage the aforementioned trajectory classification module and trajectory table to determine likely labels for an event-prediction model in near real-time fashion. The initial state of one example approach is disclosed in FIG. 3. In general, embodiments of the elements indicated in FIG. 3 are disclosed in the Appendix hereto and/or in the '638 Application. In more detail, a trajectory table T 302 may be held at a near edge node 304. Further, at an edge node 306, such as a mobile device for example, there may be a sensor stream Sⁱ 308 from which the most recent measurements by sensors 310 are input to an event detection model M 312, which may operate to generate event indications q, and from which a trajectory classifier module C 314 may determine a current trajectory class c. That is, the trajectory classifier module C 314 may determine a current trajectory class c from the sensor stream Sⁱ 308.

D.2.1 Offline Processing

Following is a discussion of some example operations of an embodiment that may be performed offline, that is, prior to a real-time inferencing process performed by an ML model. In an embodiment, the first operation is to determine a confidence threshold. This confidence threshold determines a cut-off value for the operator historical data to be considered. As shown in the example of FIG. 4, the original trajectory table may be filtered by operator efficiency score. Particularly, the table T 402 may contain historical data for all operators in the domain, such as forklift operators in a warehouse environment for example. An embodiment may apply 404 a filter such that only operators with an efficiency score equal to, or higher than, the threshold are kept in the filtered table T′ 406. These are denoted at 408 in FIG. 4.

From a subset of the columns in the filtered table T′ 406, an embodiment may obtain an operator response time 410 for each instance in the filtered table T′ 406. The specific method to compute the operator response time may vary according to the domain. In an embodiment, the computation may comprise a straightforward computation of the time that passes between a time between an alarm as raised by the model M and the time to action performed by the operator. It may be, in some embodiments, that the operator response time and/or other information may be included in the filtered table T′ 406 directly, as suggested by the ‘additional attributes’ columns 412 in the filtered table T′ 406.

As further indicated in the example of FIG. 4, a domain according to one embodiment defines a set of operator actions a that may be taken by an operator in response to the occurrence of an event q that was predicted by the model M. In the example of FIG. 4, a={Brake, Accelerate} but more, fewer, and/or different, actions may be defined for other domains. FIG. 4 further indicates that the filtered table T′ 406 may contain None values as well, indicating that none of the actions in a were executed following the prediction q.

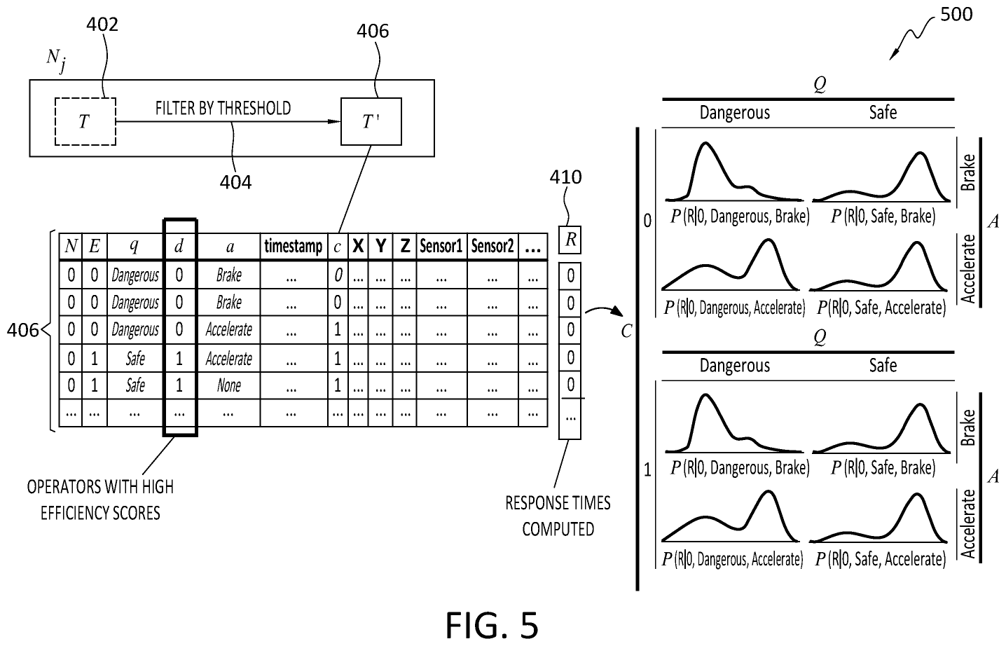

As shown in FIG. 5, the information in the filtered table T′ 406 may be used to obtain distributions Pr(R|c, q, a), collectively denoted at 500, of the operator response times for each action a∈A under a trajectory class c, and model prediction q. More specifically, FIG. 5 discloses how 4 such distributions are defined for each trajectory class c in the present example. There are 4 distributions in this example because there are 2 types of events (‘dangerous’ and ‘safe’), and 2 possible actions (‘brake’ and ‘accelerate’). More generally, one or more embodiments may operate to obtain one such distribution for each applicable pair of action event-class in a domain.

Formally, “event-classes” Q are all the possible values of q in the domain, that is, the outputs of the event prediction model M, in the present example. In the example of FIG. 5, Q={Dangerous, Safe} are the event-classes, but other embodiments may include multiple classes, and/or other, classes. Moreover, a set Qᵢ⊂ Q of event-classes of interest may be defined, possibly using prior domain knowledge. An example in the logistics domain may configure Qᵢ={Dangerous}—that is, if only predictions of Dangerous cornerings are considered to be of interest. Again, different embodiments may comprise larger and/or different sets of such classes. The examples in FIG. 5 consider Qᵢ=Q, which comprises a typical approach for some embodiments.

With continued reference to the example of FIG. 5, it is noted that the histograms may be obtained straightforwardly from the table 406, although some embodiments may assume that continuous distributions approximating those histograms may be obtained either by automatic assessment or domain expert intervention. This may be performed by any appropriate method, such as density estimation approaches, for example. The near edge, such as the near edge node(s) 110, may thus hold a set of precomputed distributions Pr (R|c, q, a) for each trajectory class, for each event-class of interest, and for each action in the domain. These may be used in an online phase, on-demand, as discussed hereafter.

D.2.2 Online Stage

During real time operation, an edge node may identify its current trajectory class c using the trajectory classification module, as disclosed in FIG. 3. This could be done with methods such as the ones described in U.S. patent application Ser. No. 17/585,055, entitled EDGE-ENABLED INDOOR TRAJECTORY MAP ACQUISITION FROM MULTIPLE ENTITIES' POSITIONAL DATA,” and filed 26 Jan. 2022 (incorporated herein in its entirety by this reference). Other kinds of approaches could be used, for example, approaches based on time series subsequence similarity.

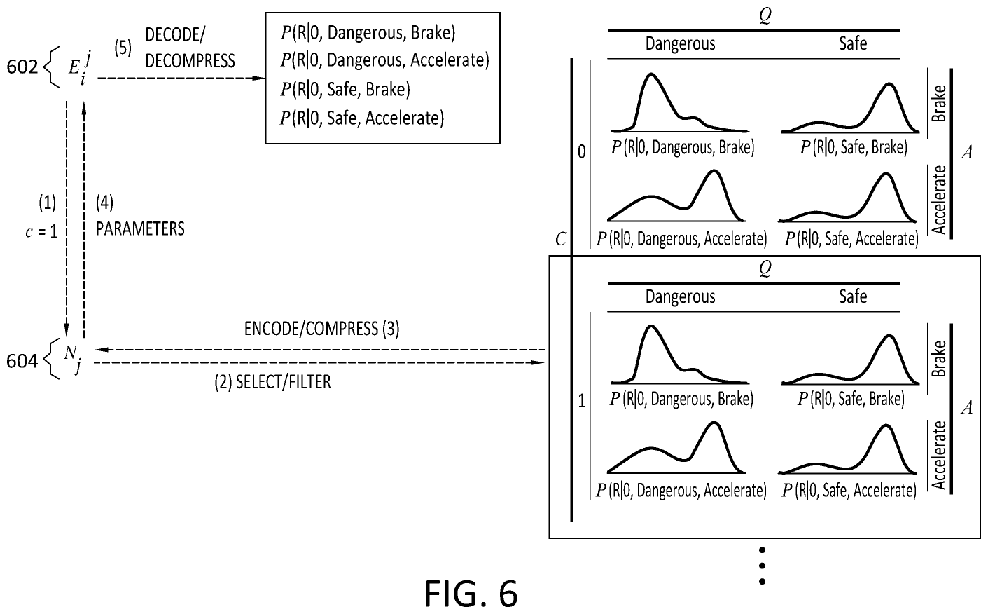

As indicated in FIG. 6, the detected class c may be communicated (1) by an edge node 602 to the near edge node 604, which may then obtain the appropriate distributions for that trajectory class. Particularly, FIG. 6 discloses that after receiving (1) the detected class c information from the edge node 602, the near-edge node 604 may select (2) and, after receiving (3) the encoded/compressed selected distributions, communicate (4), to the edge node 602, the appropriate distributions for the selected trajectory class.

Thus, FIG. 6 discloses how, in an example embodiment, the near edge node 604 obtains all the distributions related to a trajectory class, regardless of event-class and action. These are communicated (4) to the edge node 602, which may comprise a mobile device, for example. The communication process may comprise a particular encoding and/or compression, and corresponding decoding/decompression (5), if network overheads are of concern and sufficient processing is available at the far-edge node. In that case, as disclosed in FIG. 6, it may be that only the sufficient parameters for the definition of the distributions are communicated (4).

In the example disclosed in the Figures, this means one distribution of response times between a prediction of a Dangerous event and a Brake action, and one distribution of response times between a prediction of a Dangerous event and an Accelerate action, and so forth. Notice that smaller subsets Qᵢ of Q will affect the total number of such distributions that are obtained and communicated to the edge device. Also, recall that these distributions originate from the historical data regarding the responses of trusted operators. Hence, one or more embodiments may consider this historical data, concerning trusted operators, as a trusted baseline which may be used to compare the current actions of the operators when performing similar trajectories, that is, trajectories in the same trajectory class(es).

An online stage according to some embodiments may further comprise detecting the predictions of interest. No additional orchestration may be required for this—the event detection model M is already deployed and may yield a prediction q. If q∉Qᵢ, an embodiment may not perform the operations set forth hereafter. In this regard, recall from the earlier discussion the definition of the event-classes of interest Qᵢ.

Otherwise, if q∈Qᵢ, an embodiment may we monitor the actions taken by the operator, and associated response times, and check whether the actions and response times seem within expectations given the distributions. That is, when an action is detected, an embodiment may perform the following operations:
1. determine the response time—that is, the time it took for the operator to perform the action after the model prediction;
2. determine whether that response time is within expectations, according to the distribution of response times (for that action, given that event, for the current trajectory class) that was obtained from trusted operators;
3. if the response time is within expectations, at least tentatively determine that the model's prediction was correct and assign it a true label;
4. otherwise determine whether that response time is within expectations for a different event class predicted—that is, if the response time of the operator is more similar to the response time of trusted operators when presented with a different model prediction;
5. then, tentatively determine that the prediction made by the model was incorrect and assign the prediction a false label; and
6. otherwise flag this model prediction as suspicious, since it may not be possible to tentatively affirm a label, or, optionally, a false label may be defined for the prediction.

Formally, and given an action a∈A, an embodiment may perform the following operations in connection with the online operation of a model M:
1. define a minimum decision threshold z;
2. compute the current response time r of the operator for the prediction of interest;
3. compute the probability p=P(R=r|c, q, a);
4. if p≥z, determine, at least tentatively, a true label for that prediction;
5. otherwise, if that probability is smaller than the threshold:
   a. for each other event of interest \hat{q}∈Qᵢ, q̅≠q, compute \hat{p}=Pr (R=r|c, \hat{q}, a);
   b. if \hat{p}≥z: determine a false label for that prediction; and
6. otherwise, signal that operator action as suspicious, or potentially anomalous, or optionally determine a false label, as described below.

A few remarks now concerning some example embodiments. In some embodiments, the assignment of true or false labels for the event predictions may assume strict Boolean values, that is, either 1 (true) or 0 (false). Other embodiments however may assume the labels provided also represent a confidence in the label assignment, that is, a confidence that the correct label has been assigned. The assignment of a tentative true label in in part 4. (where it is given that an action a∈A) may additionally comprise associating a confidence score to that label assignment, which in this case may straightforwardly reflect the value of p.

In part 5b. (where it is given that an action a∈A), that is, the scenario in which the probability of r relating to another event-class is larger than the probability of r relating to the predicted event-class, an embodiment may assign a tentative false label for that prediction. In this case, an embodiment may compute a confidence score of that label as \hat{p}−p, where \hat{p} is the maximum obtained from all the alternative event-classes, that is, that yields the highest probability.

Furthermore, it is noted that part 5 (where it is given that an action a∈A) may require that multiple event-classes of interest exist. For example, if an embodiment considers only Qᵢ={Dangerous} in the domain of interest, one embodiment of the algorithm, embodied as 1. through 6., may not be capable of assigning false labels to any predictions. That algorithm may, however, still be able to determine tentative true labels, though, and may still be used to identify most-likely anomalous samples.

Note further that if too few classes, or a single class, are considered of interest, then part 6 (where it is given that an action a∈A) may further comprise assigning a tentative false label to the prediction. In that case, a confidence score for that label assignment may be determined as z−p. Otherwise, the event-predictions in part 6 may instead be signaled for human revision and/or disregarded as part of the resulting set of labels obtained by one embodiment.

Finally, the obtaining of tentative labels in an online fashion may enable many kinds of management and orchestration approaches. For example, performance-based drift detection techniques is an example of an application that may leverage such labels as provided by one or more of the disclosed embodiments.

### E. Further Discussion

As will be apparent from this disclosure, example embodiments may possess various useful aspects and features. Following is a non-exhaustive list of such aspects and features.

Among other things, an embodiment may comprise a method for obtaining tentative labels of event prediction models in an edge environment in an online fashion, relying on a previously collected trajectory table and previously defined efficiency scores for the operators under specific trajectory classes.

An embodiment may comprise the offline determination of distributions of action response times for each event prediction class, considering trusted operators' historical data.

An embodiment may comprise the online orchestration of offline distributions, relying on a trajectory classification approach.

An embodiment may comprise the computation of probabilities, relating the current action response time following a prediction to those distributions.

An embodiment may comprise an algorithm to determine a tentative true or false label to the event prediction. The embodiment may also provide tentative labels for an event prediction with an associated confidence score. Additionally, the embodiment may comprise indicating likely anomalous actions, based on the extraordinary response times by an operator. This embodiment may or may not assign a (false) label for such cases.

### F. Example Methods

It is noted with respect to the disclosed methods, including the example method of Figure X, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

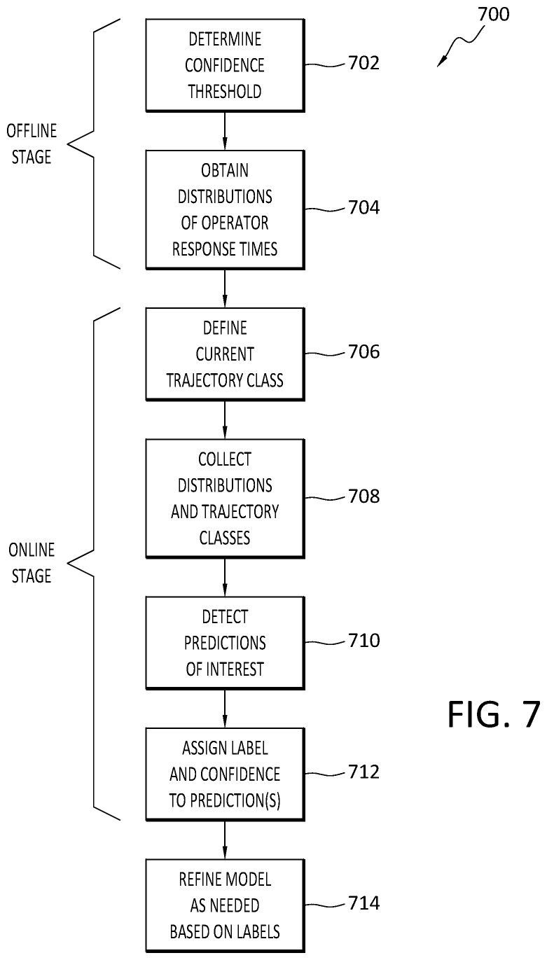

Directing attention now to FIG. 7, and with continued reference to the example operations disclosed in FIG. 6, an example method according to one embodiment is denoted generally at 700. In one example, the method 700 may comprise a combination of offline operations, and online operations. The offline operations may comprise, for example, the gathering of data, and using that data to train an ML model. The online operations, which may be performed without the benefit of any prediction labels, or only a few such labels, may comprise running the model in real time, using production data as an input to the model. An output of the model may comprise one or more labels that may then be assigned to a prediction generated by the model. In an embodiment, the offline operations may be performed, for example, by an entity that provides an ML model as-a-Service to one or more clients. One, some, or all, of the online operations may be performed by, and/or at the direction of, the ML model, respective instances of which may run at each edge node in a group of edge nodes. In an embodiment, one or more of the online operations may be cooperatively performed by an edge node and a near edge node, and the near edge node and a central node may be elements of a service provider site that may train and provide a model for use by clients, such as edge nodes. In general however, no particular allocation of the functions disclosed herein, including in FIG. 7, is necessarily required. As such, the allocation disclosed in FIG. 7 is presented only by way of example, and is not intended to limit the scope of the invention in any way.

The example method 700 may being with the determination of a confidence threshold 702. In general, this may involve determining, using historical information, which operator(s) in a group of operators have a sufficiently high efficiency score. The process 702 may result in definition of a filtered table, examples of which are disclosed herein, that may include operator response times.

Next, a distribution of the operator response times may be obtained 704. Particularly, the distribution may be a distribution of operator response times for each action, of a defined domain of actions, under a particular trajectory class c, and model prediction q. In an embodiment, these distributions may be held at a near edge node that is operated to communicate with a central node, and with a group of edge nodes. In an embodiment, the completion of 704 may comprise the end of an offline stage of the method 700.

At some point after conclusion of the offline stage, one or more of the edge nodes may define 706 their current trajectory class, possibly using a trajectory classification module, examples of which are disclosed herein. This trajectory class information may be collected 708 from the edge nodes by a near edge node which, as noted above, may also hold the distributions obtained 704 previously. The trajectory classes may then be used, such as by the near edge node, to obtain the appropriate corresponding distributions which may then be sent to the edge nodes.

The edge nodes may use the distributions received from the near edge node to detect 710 a prediction of interest. An evaluation may then be performed by the model instance running at an edge node to assign a label 712 to the detected prediction. In an embodiment, the performance of 712 may concluded an online stage of the method 700. Depending upon the label assigned to a particular prediction generated by the model, the model may then be refined 714 in an attempt to obtain better, and more accurate predictions for detected events.

### G. Further Example Embodiments

Following are some further example embodiments of the invention. These are presented only by way of example and are not intended to limit the scope of the invention in any way.

Embodiment 1. A method, comprising: receiving, by a near edge node from a far edge node, a trajectory class determined by the far edge node; selecting, by the near edge node, a distribution that corresponds to the trajectory class; receiving, by the near edge node, the distribution; and transmitting, by the near edge node to the far edge node, the distribution, wherein the distribution is usable by the far edge node to determine a label to be assigned to a prediction of interest generated by a model instance running at the edge node.

Embodiment 2. The method as recited in embodiment 1, wherein the trajectory class was determined using a trajectory classification module.

Embodiment 3. The method as recited in any of embodiments 1-2, wherein the distribution comprises a response time between prediction of a particular event, and a time when an action corresponding to the particular event was initiated.

Embodiment 4. The method as recited in any of embodiments 1-3, wherein when the label is ‘true,’ the label indicates that the prediction of interest was correct, and wherein when the label is ‘false,’ the label indicates that the prediction of interest was incorrect.

Embodiment 5. The method as recited in any of embodiments 1-4, wherein the distribution comprises historical information about action response times for an event prediction class.

Embodiment 6. The method as recited in any of embodiments 1-5, wherein the distribution is generated using a filtered table that comprises a list of operators that have met or exceeded a defined efficiency standard.

Embodiment 7. The method as recited in any of embodiments 1-6, wherein the near edge node is an element of a provider site that is operable to train the model instance, and to provide the model instance as a service to a group of edge nodes that includes the edge node.

Embodiment 8. The method as recited in any of embodiments 1-7, wherein the distribution comprises a distribution of operator response times for each action a∈A under the trajectory class, and model instance prediction.

Embodiment 9. The method as recited in any of embodiments 1-8, wherein the prediction of interest concerns a specified event class that is an element of a domain of event classes.

Embodiment 10. The method as recited in any of embodiments 1-9, wherein the far edge node comprises a mobile device.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

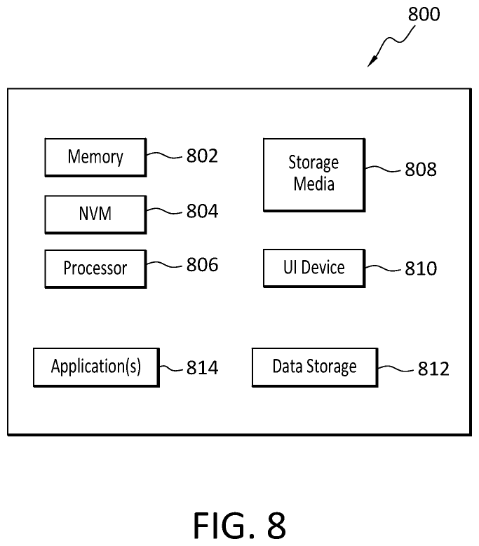

With reference briefly now to FIG. 8, any one or more of the entities disclosed, or implied, by FIGS. 1-7 [I.E., ALL OTHER FIGURES IN THE APPLICATION] and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI (user interface) device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a near edge node from a far edge node, a trajectory class determined by the far edge node;
selecting, by the near edge node, a distribution that corresponds to the trajectory class;
receiving, by the near edge node, the distribution; and
transmitting, by the near edge node to the far edge node, the distribution, wherein the distribution is usable by the far edge node to determine a label to be assigned to a prediction of interest generated by a model instance running at the edge node.

2. The method as recited in claim 1, wherein the trajectory class was determined using a trajectory classification module.

3. The method as recited in claim 1, wherein the distribution comprises a response time between prediction of a particular event, and a time when an action corresponding to the particular event was initiated.

4. The method as recited in claim 1, wherein when the label is ‘true,’ the label indicates that the prediction of interest was correct, and wherein when the label is ‘false,’ the label indicates that the prediction of interest was incorrect.

5. The method as recited in claim 1, wherein the distribution comprises historical information about action response times for an event prediction class.

6. The method as recited in claim 1, wherein the distribution is generated using a filtered table that comprises a list of operators that have met or exceeded a defined efficiency standard.

7. The method as recited in claim 1, wherein the near edge node is an element of a provider site that is operable to train the model instance, and to provide the model instance as a service to a group of edge nodes that includes the edge node.

8. The method as recited in claim 1, wherein the distribution comprises a distribution of operator response times for each action a∈A under the trajectory class, and model instance prediction.

9. The method as recited in claim 1, wherein the prediction of interest concerns a specified event class that is an element of a domain of event classes.

10. The method as recited in claim 1, wherein the far edge node comprises a mobile device.

11. A non-transitory storage medium having stored therein instructions that are executable by one or more hardware processors to perform operations comprising:
receiving, by a near edge node from a far edge node, a trajectory class determined by the far edge node;
selecting, by the near edge node, a distribution that corresponds to the trajectory class;
receiving, by the near edge node, the distribution; and
transmitting, by the near edge node to the far edge node, the distribution, wherein the distribution is usable by the far edge node to determine a label to be assigned to a prediction of interest generated by a model instance running at the edge node.

12. The non-transitory storage medium as recited in claim 11, wherein the trajectory class was determined using a trajectory classification module.

13. The non-transitory storage medium as recited in claim 11, wherein the distribution comprises a response time between prediction of a particular event, and a time when an action corresponding to the particular event was initiated.

14. The non-transitory storage medium as recited in claim 11, wherein when the label is ‘true,’ the label indicates that the prediction of interest was correct, and wherein when the label is ‘false,’ the label indicates that the prediction of interest was incorrect.

15. The non-transitory storage medium as recited in claim 11, wherein the distribution comprises historical information about action response times for an event prediction class.

16. The non-transitory storage medium as recited in claim 11, wherein the distribution is generated using a filtered table that comprises a list of operators that have met or exceeded a defined efficiency standard.

17. The non-transitory storage medium as recited in claim 11, wherein the near edge node is an element of a provider site that is operable to train the model instance, and to provide the model instance as a service to a group of edge nodes that includes the edge node.

18. The non-transitory storage medium as recited in claim 11, wherein the distribution comprises a distribution of operator response times for each action a∈A under the trajectory class, and model instance prediction.

19. The non-transitory storage medium as recited in claim 11, wherein the prediction of interest concerns a specified event class that is an element of a domain of event classes.

20. The non-transitory storage medium as recited in claim 11, wherein the far edge node comprises a mobile device.
